(19) United States
(12) Patent Application Publication
(10) Pub. No.: US 2023/0180964 A1
(43) Pub. Date: Jun. 15, 2023

(54) ANTI-OVERFLOW COOKING UTENSIL WITH STABLE SUPPORT

(71) Applicant: SHENZHEN BOLTON TECHNOLOGY CO., LTD., Shenzhen (CN)

(72) Inventor: HUAZHU LIU, Heze (CN)

(21) Appl. No.: 17/571,524

(22) Filed: Jan. 9, 2022

(30) Foreign Application Priority Data
Dec. 13, 2021 (CN) 2021115034142

(51) Int. Cl. A47J 36/10; A47J 36/34; A47J 45/06

(52) U.S. Cl. CPC A47J 36/10; A47J 36/34; A47J 45/061; A47J 45/063

(57) ABSTRACT

An anti-overflow cooking utensil with stable support includes a pot body, a pot cover, a handle, ear handles, and rectangular openings. The pot cover is disposed on an upper portion of the pot body, an anti-overflow ring is fixedly disposed at one end of an inner wall of the pot cover, a handle is connected to an upper portion of the pot cover, a supporting block is fixedly disposed at each of two opposite ends of a bottom of the pot body, fixing blocks are fixedly disposed at upper ends of two opposite sides of the pot body. In the present disclosure, two pressing columns are compressed on other two sides of the pot cover, cooperating with other two sets of pressing wheels to realize a pressing of four positions of the pot cover, which further improves stability and anti-slip performance.

### TECHNICAL FIELD

The present disclosure relates to a technical field of cooking utensils, in particular to an anti-overflow cooking utensil with stable support.

### BACKGROUND

Cooking refers to an art of diet, which is a complex and regular processing of transforming food materials into food, and is a way and method of processing food materials to make the food more delicious, better looking and better smelling. A delicious food must have good color, aroma, artistic conception, shape, and nutrition, which not only makes people feel satisfied when eating, but also makes nutrition of food easier to be absorbed by the people. And cooking utensils are needed when cooking.

A pot cover and a pot body of most of existing cooking utensils are separated. People need to put the food materials into the pot body, and cover the pot cover on the pot body, then put the pot body on a pot holder. However, there is no temporary pressing mechanism between the pot cover and the pot body, so that the pot cover is easy to slide and be damaged when the pot cover is lifted and moved. In addition, the pot cover and a handle on the pot cover are usually fixed by a bolt, which is easy to loosen after long-term use. Therefore, the present disclosure provides an anti-overflow cooking utensil with stable support.

### SUMMARY

A purpose of the present disclosure is to solve the above problems in prior art, and an anti-overflow cooking utensil with stable support is proposed.

In order to achieve the above purpose, the present disclosure adopts following technical solutions:

An anti-overflow cooking utensil with stable support, including a pot body, a pot cover, a handle, ear handles, and rectangular openings. The pot cover is disposed on an upper portion of the pot body, and an anti-overflow ring is fixedly disposed at one end of an inner wall of the pot cover. A handle is connected to an upper portion of the pot cover, and a tensioning mounting mechanism is disposed between the handle and the pot cover. A supporting block is fixedly disposed at each of two opposite ends of a bottom of the pot body, and fixing blocks are fixedly disposed at upper ends of two opposite sides of the pot body. First pin shafts, penetrating through outer walls of two sides of each of the fixing blocks, are rotatably disposed on the pot body, and ear handles are respectively and fixedly disposed at two ends of each of the first pin shafts. The rectangular openings, penetrating through outer walls of two sides of each of the ear handles, are respectively defined on each of the ear handles. L-shaped rods are respectively disposed on each of two sides of the pot body near the ear handles, and upper ends of the L-shaped rods respectively penetrate through the rectangular openings. Rotating shafts, penetrating through the outer walls of the two sides of the L-shaped rods, are rotatably disposed at the upper ends of the L-shaped rods. Pressing wheels are fixedly disposed at two ends of each of the rotating shafts, and auxiliary pressing mechanisms are disposed on outer walls of the two sides of the pot body.

Furthermore, limiting pins are fixedly disposed at two ends of an upper portion of each of the fixing blocks, limiting strips are fixedly disposed at two ends of a lower portion of each of the fixing blocks, and a free rotation gap is formed between a respective one of the limiting pins and a respective one of the limiting strips. A connecting strip is horizontally and fixedly disposed on an inner wall of one side of each of the rectangular openings, a roller is rotatably disposed in one section of the connecting strip, the roller is connected to one side of a respective one of the L-shaped rods, and a plurality of anti-skid protrusions are disposed at one end of a lower portion of each of the ear handles.

Furthermore, each of the auxiliary pressing mechanisms includes a fixing sleeve fixedly disposed on a lower portion of an outer wall of each of two opposite sides of the pot body. A second pin shaft, penetrating through two ends of the fixing sleeve, is rotatably disposed at the fixing sleeve. A first torsion spring is disposed between the second pin shaft and the fixing sleeve, two ends of the second pin shaft are both fixedly connected with two connecting rods, and a grounding roller is rotatably disposed on lower portions of the two connecting rods. Two L-shaped columns are fixedly disposed on upper ends of the connecting rods, and a pressing column is fixedly disposed on upper ends of the two L-shaped columns.

Furthermore, the tensioning mounting mechanism includes a through opening defined in a middle portion of the pot cover. A sealing sleeve is respectively and fixedly disposed along one end of an inner wall of the through opening, a connecting sleeve is respectively disposed at an upper end of the sealing sleeve, a limiting ring is fixedly sleeved on an outer wall of the connecting sleeve, and the limiting ring is in contact with an upper portion of the sealing sleeve. An upper end of the connecting sleeve is rotatably connected with the handle, a plug is inserted between a lower end of the sealing sleeve, and a clamping connection assembly is disposed between the plug and the connecting sleeve.

Furthermore, the clamping connection assembly includes a sliding sleeve slidably inserted in the connecting sleeve, an inner thread is disposed along an upper end of an inner wall of the sliding sleeve, a threaded column is fixedly disposed at a middle position of a lower portion of the handle, the threaded column is in threaded connection with an upper end of the sliding sleeve, an annular clamping groove is defined in a lower end of the sliding sleeve along the inner wall of the sliding sleeve, clamping rods are respectively and rotatably disposed on two sides of an upper portion of the plug, a clamping head is disposed on an upper portion of each of the clamping rods, the clamping head is matched with the annular clamping groove, and a second torsion spring is disposed at a position where the clamping rod is rotatably connected with the plug.

Furthermore, side grooves are respectively defined in lower portions of inner walls of two sides of the connecting sleeve, sliding blocks are fixedly disposed on outer walls of two sides of the sliding sleeve, and the sliding blocks are respectively and slidably disposed in the side grooves.

Furthermore, one end of a spring is fixedly connected to an inner top wall of each of the side grooves, and an other end of the spring is fixedly disposed on an upper portion of each of the sliding blocks.

Furthermore, two magnetic blocks are respectively and fixedly disposed on the inner top wall of each of the side grooves and the upper portion of each of the sliding blocks, and the two magnetic blocks re magnetically repulsive

Beneficial effects of the present disclosure are as follows:

1. By rotating the ear handles on two sides of the pot body, and cooperating with the L-shaped rods disposed at a position near the ear handles on two sides of the pot body and the pressing wheels disposed at one end of each of the L-shaped rods, people may hold the two ear handles to make the ear handles rotate upward. Due to a limiting effect of the limiting pins, the ear handles may be only rotated upward for a certain distance, the roller inside the rectangular openings is driven to press and push the L-shaped rods to rotate, so that the two pressing wheels are pressed on an upper portion of the pot cover, which realizes compression and fixation on two sides of the pot cover, thereby avoiding the pot cover from sliding down when the people lift the pot body and further avoiding an overflow of internal soup during a moving process, and further plays an anti-overflow function.

2. The auxiliary pressing mechanism is disposed on the outer walls of two sides of the pot body to separate the grounding roller from a table surface after the pot body is lifted. The second pin shafts, driven by the second torsion spring, drives the two connecting rods to rotate back, and drives the two L-shaped columns to rotate to one side of the pot body, so that the two pressing columns are compressed on the other two sides of the pot cover. The above two groups of the pressing wheels are cooperated to tightly press four positions of the pot cover, which improves stability and anti-slip performance of the anti-overflow cooking utensil with stable support. When people finish cooking, the two grounding rollers are in contact with the table surface and are pressed to rotate and tilt toward one side of the pot body. The connecting rods stop sliding after being blocked by a side wall of the pot body. As a result, a height of the two grounding rollers is same as a height of the two supporting blocks, and four supporting points are formed at a bottom of the pot body to avoid the table surface from being in direct contact with a hot pot bottom and further avoid the table surface from being damaged.

3. By providing tensioning installation mechanism between the handle and the pot body, when people install the handle, the people may insert the connecting sleeve into an upper end of the sealing sleeve, and insert the two clamping rods on the plug between the inner wall of the sliding sleeve. And the clamping heads of the two clamping rods are clamped into the annular clamping groove, and then the handle is rotated to make the threaded column rotate and drive the sliding sleeve to move up. The two clamping rods drive the plug into the sealing sleeve until the plug is clamped and fixed, which is different from a conventional method of fixing the handle with bolts, so that the anti-overflow cooking utensil with stable support of the present disclosure is not easy to loosen and has a good anti-rust effect.

### BRIEF DESCRIPTION OF DRAWINGS

FIG. 1 is a three-dimensional structural schematic diagram of an anti-overflow cooking utensil with stable support of the present disclosure.

FIG. 2 is a three-dimensional structural schematic diagram of one of ear handles of the anti-overflow cooking utensil with stable support of the present disclosure.

FIG. 3 is a three-dimensional structural schematic diagram of a bottom surface of one of the ear handles of the anti-overflow cooking utensil with stable support of the present disclosure.

FIG. 4 is a three-dimensional structural schematic diagram of one of auxiliary pressing mechanisms of the anti-overflow cooking utensil with stable support of the present disclosure.

FIG. 5 is a plane cross-sectional structural schematic diagram of a pot cover of the anti-overflow cooking utensil with stable support of the present disclosure.

FIG. 6 is a partial enlarged structural diagram of the anti-overflow cooking utensil with stable support of the present disclosure.

FIG. 7 is a plane cross-sectional structural schematic structural diagram of a sealing sleeve according to embodiment 1 of the anti-overflow cooking utensil with stable support of the present disclosure.

FIG. 8 is a plane cross-sectional structural schematic structural diagram of the sealing sleeve according to embodiment 2 of the anti-overflow cooking utensil with stable support of the present disclosure.

Reference number in the figures: pot body 1, pot cover 2, handle 3, ear handle 4, rectangular opening 5, fixing block 6, first pin shaft 7, L-shaped rod 8, rotating shaft 9, limiting pin 10, pressing wheel 11, anti-skid protrusion 12, connecting strip 13, roller 14, limiting strip 15, fixing sleeve 16, grounding roller 17, connecting rod 18, L-shaped column 19, supporting block 20, sealing sleeve 21, plug 22, connecting sleeve 23, limiting ring 24, side groove 25, clamping rod 26, sliding block 27, sliding sleeve 28, annular clamping groove 29, threaded column 30, pressing column 31, second pin shaft 32, magnetic block 33, spring 34, anti-overflow ring 35.

### DETAILED DESCRIPTION

Technical solutions in embodiments of the present disclosure will be clearly and completely described below with reference to accompanying drawings in the embodiments of the present disclosure. Obviously, the described embodiments are only parts of the embodiments of the present disclosure, rather than all of the embodiments.

It should be noted that, in case of no conflict, the embodiments in the present application and the features in the embodiments can be combined with each other. The present disclosure will be described in detail below with reference to the accompanying drawings and in combination with the embodiments.

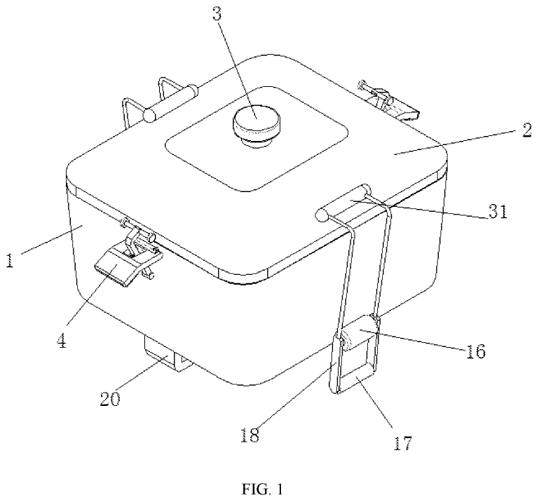

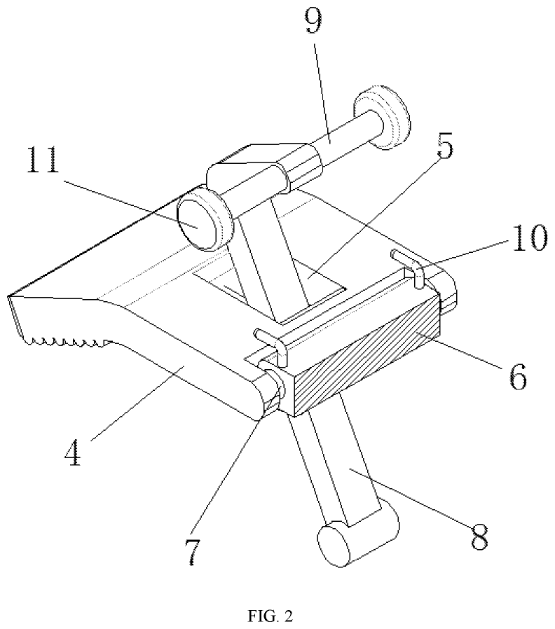

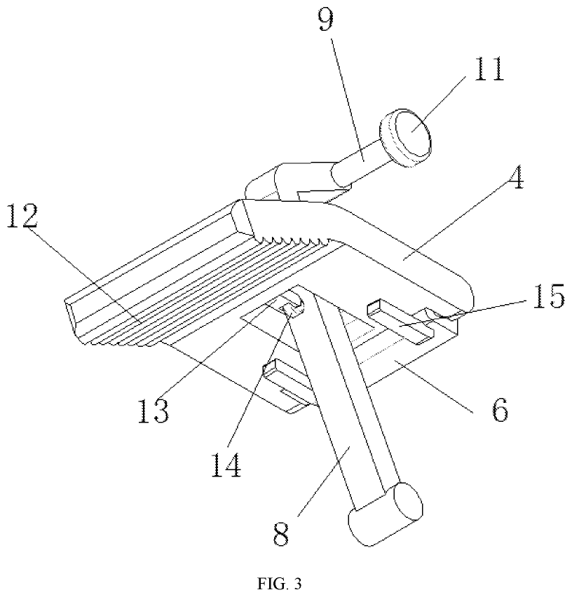

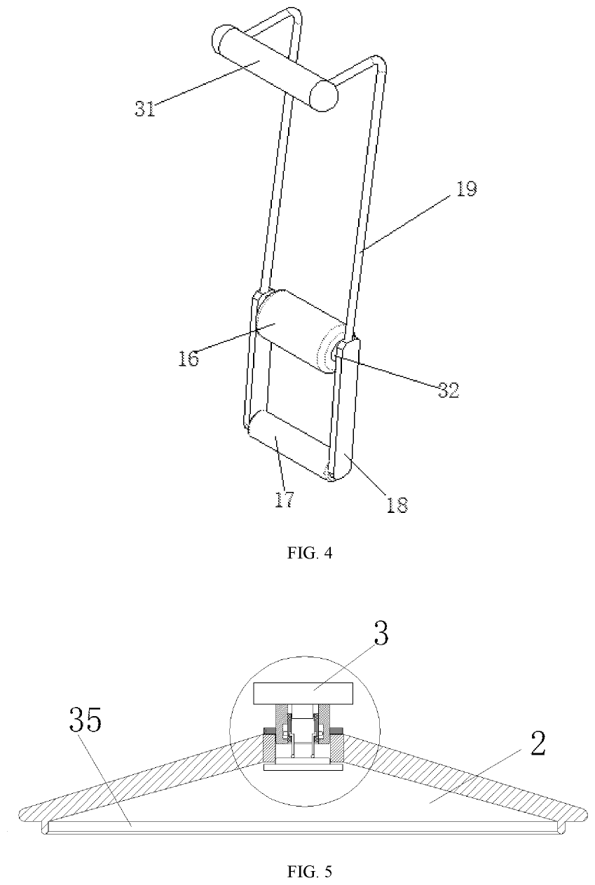

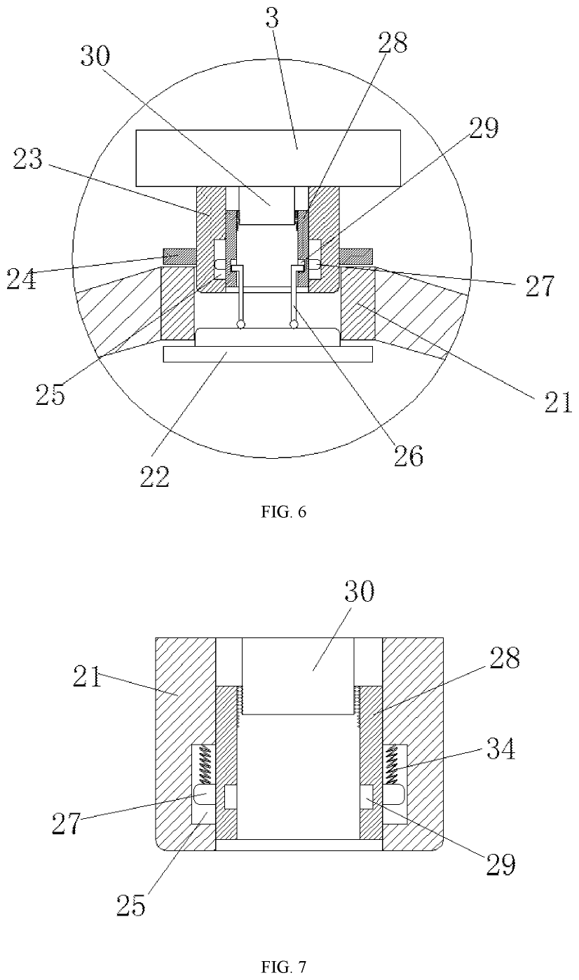

As embodiment 1, with reference to FIGS. 1-7, the present disclosure provides an anti-overflow cooking utensil with stable support, including a pot body 1, a pot cover 2, a handle 3, ear handles 4, and rectangular openings 5. The pot cover 2 is disposed on an upper portion of the pot body 1, an anti-overflow ring 35 is fixedly disposed at one end of an inner wall of the pot cover 2, a handle 3 is connected to an upper portion of the pot cover 2, a tensioning mounting mechanism is disposed between the handle 3 and the pot cover 2, a supporting block 20 is fixedly disposed at each of two opposite ends of a bottom of the pot body 1, fixing blocks 6 are fixedly disposed at upper ends of two opposite sides of the pot body 1, first pin shafts 7, penetrating through outer walls of two sides of each of the fixing blocks, are rotatably disposed on the pot body 1, ear handles 4 are respectively and fixedly disposed at two ends of each of the first pin shafts 7, the rectangular openings 5, penetrating through outer walls of two sides of each of the ear handles 4, are respectively defined on each of the ear handles 4, L-shaped rods 8 are respectively disposed on each of two sides of the pot body 1 near the ear handles 4, upper ends of the L-shaped rods 8 respectively penetrate through the rectangular openings 5, rotating shafts 9, penetrating through the outer walls of the two sides of the L-shaped rods 8, are rotatably disposed at the upper ends of the L-shaped rods 8, pressing wheels 11 are fixedly disposed at two ends of each of the rotating shafts 9, and auxiliary pressing mechanisms are disposed on outer walls of the two sides of the pot body 1.

In the embodiment, limiting pins 10 are fixedly disposed at two ends of an upper portion of each of the fixing blocks 6, limiting strips 15 are fixedly disposed at two ends of a lower portion of each of the fixing blocks 6, a free rotation gap is formed between a respective one of the limiting pins 10 and a respective one of the limiting strips 15, a connecting strip 13 is horizontally and fixedly disposed on an inner wall of one side of each of the rectangular openings 5, a roller 14 is rotatably disposed in one section of the connecting strip 13, the roller 14 is connected to one side of a respective one of the L-shaped rods 8, and a plurality of anti-skid protrusions 12 are disposed at one end of a lower portion of each of the ear handles 4.

Specifically, each of the auxiliary pressing mechanisms includes a fixing sleeve fixedly disposed on a lower portion of an outer wall of each of two opposite sides of the pot body 1. A second pin shaft 32, penetrating through two ends of the fixing sleeve 16, is rotatably disposed at the fixing sleeve 16, a first torsion spring is disposed between the second pin shaft 32 and the fixing sleeve 16, two ends of the second pin shaft 32 are both fixedly connected with two connecting rods 18, a grounding roller 17 is rotatably disposed on lower portions of the two connecting rods 18, two L-shaped columns 19 are fixedly disposed on upper ends of the connecting rods 18, and a pressing column 31 is fixedly disposed on upper ends of the two L-shaped columns 19.

Furthermore, the tensioning mounting mechanism includes a through opening defined in a middle portion of the pot cover 2. A sealing sleeve 21 is respectively and fixedly disposed along one end of an inner wall of the through openings, a connecting sleeve 23 is respectively disposed at an upper end of the sealing sleeve 21, a limiting ring 24 is fixedly sleeved on an outer wall of the connecting sleeve 23, and the limiting ring 24 is in contact with an upper portion of the sealing sleeve 21. An upper end of the connecting sleeve 23 is rotatably connected with the handle 3, a plug 22 is inserted between a lower end of the sealing sleeve 21, and a clamping connection assembly is disposed between the plug 22 and the connecting sleeve 23.

Specifically, the clamping connection assembly includes a sliding sleeve 28 slidably inserted in the connecting sleeve 23, an inner thread is disposed along an upper end of an inner wall of the sliding sleeve 28, a threaded column 30 is fixedly disposed at a middle position of a lower portion of the handle 3, the threaded column 30 is in threaded connection with an upper end of the sliding sleeve 28, an annular clamping groove 29 is defined in a lower end of the sliding sleeve 28 along the inner wall of the sliding sleeve 28, clamping rods 26 are respectively and rotatably disposed on two sides of an upper portion of the plug 22, a clamping head is disposed on an upper portion of each of the clamping rods 26, the clamping head is matched with the annular clamping groove 29, and a second torsion spring is disposed at a position where the clamping rod 26 is rotatably connected with the plug 22.

Specifically, side grooves 25 are respectively defined in lower portions of inner walls of two sides of the connecting sleeve 23, sliding blocks 27 are fixedly disposed on outer walls of two sides of the sliding sleeve 28, and the sliding blocks 27 are respectively and slidably disposed in the side grooves 25.

Specifically, one end of a spring 34 is fixedly connected to an inner top wall of each of the side grooves 25, and an other end of the spring 34 is fixedly disposed on an upper portion of each of the sliding blocks 27.

Based on above, it may be found that above mentioned embodiment 1 of the present disclosure achieves the following technical effects. When using the anti-overflow cooking utensil with stable support of the present disclosure, people hold the two ear handles 4 to make the ear handles 4 rotate upward. Due to a limiting effect of the limiting pins 10, the ear handles 4 may be only rotated upward for a certain distance, the roller 14 inside the rectangular openings 5 is driven to press and push the L-shaped rods 8 to rotate, so that the two pressing wheels 11 are pressed on an upper portion of the pot cover 2, which realizes compression and fixation on two sides of the pot cover 2, thereby avoiding the pot cover 2 from sliding down when the people lift the pot body 1. After lifting the pot body 1, the grounding roller 17 is separated from the table surface. The second pin shaft 32, driven by the second torsion spring, drives the two connecting rods 18 to rotate back, and drives the two L-shaped columns 19 to rotate to one side of the pot body 1, so that the two pressing columns 31 are compressed on the other two sides of the pot cover 2. The above two groups of the pressing wheels 11 are cooperated to tightly press four positions of the pot cover 2, which improves stability and anti-slip performance of the anti-overflow cooking utensil with stable support. When people finish cooking, the anti-overflow cooking utensil with stable support is lifted, the two grounding rollers 17 are in contact with the table surface and are pressed to rotate and tilt toward one side of the pot body 1. The connecting rods 18 stop sliding after being blocked by a side wall of the pot body 1. As a result, a height of the two grounding rollers 17 is same as a height of the two supporting blocks 20, and four supporting points are formed at a bottom of the pot body 1 to avoid the table surface from being in direct contact with a hot pot bottom and further avoid the table surface from being damaged. When installing the handle 3, the people may insert the connecting sleeve 23 between an upper end of the sealing sleeves 21, and insert the two clamping rods 26 on the plug between the inner wall of the sliding sleeve 28. And the clamping heads of the two clamping rods 26 are clamped into the annular clamping groove 29, and then the handle 3 is rotated to make the threaded column 30 rotate and drive the sliding sleeve 28 to compress the spring 34 to move up. The two clamping rods 26 drive the plug into the sealing sleeves 21 until the plug is clamped and fixed, which is different from a conventional method of fixing the handle with bolts, so that the anti-overflow cooking utensil with stable support of the present disclosure is not easy to loosen and has a good anti-rust effect.

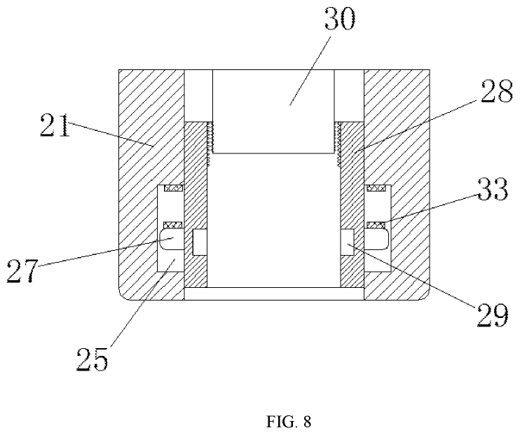

As embodiment 2, with reference to FIGS. 1-6 and FIG. 8, compared with the embodiment 1, there is only one difference exists, which is that two magnetic blocks 33 are respectively and fixedly disposed on the inner top wall of each of the side grooves 25 and the upper portion of each of the sliding blocks 27, and the two magnetic blocks 33 are magnetically repulsive.

Based on above, the present disclosure achieves the following technical effects. When using the anti-overflow cooking utensil with stable support of the present disclosure, people hold the two ear handles 4 to make the ear handles 4 rotate upward. Due to a limiting effect of the limiting pins 10, the ear handles 4 may be only rotated upward for a certain distance, the roller 14 inside the rectangular openings 5 is driven to press and push the L-shaped rods 8 to rotate, so that the two pressing wheels 11 are pressed on an upper portion of the pot cover 2, which realizes compression and fixation on two sides of the pot cover 2, thereby avoiding the pot cover 2 from sliding down when the people lift the pot body 1. After lifting the pot body 1, the grounding roller 17 is separated from the table surface. The second pin shaft 32, driven by the second torsion spring, drives the two connecting rods 18 to rotate back, and drives the two L-shaped columns 19 to rotate to one side of the pot body 1, so that the two pressing columns 31 are compressed on the other two sides of the pot cover 2. The above two groups of the pressing wheels 11 are cooperated to tightly press four positions of the pot cover 2, which improves stability and anti-slip performance of the anti-overflow cooking utensil with stable support. When people finish cooking, the anti-overflow cooking utensil with stable support is lifted, the two grounding rollers 17 are in contact with the table surface and are pressed to rotate and tilt toward one side of the pot body 1. The connecting rods 18 stop sliding after being blocked by a side wall of the pot body 1. As a result, a height of the two grounding rollers 17 is same as a height of the two supporting blocks 20, and four supporting points are formed at a bottom of the pot body 1 to avoid the table surface from being in direct contact with a hot pot bottom and further avoid the table surface from being damaged. When installing the handle 3, the people may insert the connecting sleeve 23 between an upper end of the sealing sleeves 21, and insert the two clamping rods 26 on the plug between the inner wall of the sliding sleeve 28. And the clamping heads of the two clamping rods 26 are clamped into the annular clamping groove 29, and then the handle 3 is rotated to make the threaded column 30 rotate and drive the sliding sleeve 28 to compress the magnetic blocks 33to move up. The two clamping rods 26 drive the plug into the sealing sleeves 21 until the plug is clamped and fixed, which is different from a conventional method of fixing the handle with bolts, so that the anti-overflow cooking utensil with stable support of the present disclosure is not easy to loosen and has a good anti-rust effect.

For ease of illustration, spatial relative terms are used here, such as “on”, “above”, “top”, “over”, etc., which are used to describe spatial positional relationships between one device or feature and other devices or features as shown in figures. It should be understood that the spatial relative terms are intended to encompass different orientations in use or operation other than the orientation of the device described in the figures. For example, if the device in the figures is turned upside down, the device is described as “above other devices or structures” or “over other devices or structures” will then be positioned as “below other devices or structures” or “under other devices or structures”. Thus, an exemplary term “above” may include both orientations “above” and “below”. The device is further be positioned in other different ways (turned 90 degrees or in other orientations), and a relative description of space used here shall be explained accordingly.

It should be noted that the terms used here are only for describing specific embodiments, and are not intended to limit the exemplary embodiments according to the present disclosure. As used herein, unless a context clearly indicates otherwise, a singular form is further intended to include a plural form. In addition, it should further be understood that when the terms “comprising” and/or “including” are used in this specification, they indicate that there are features, steps, operations, devices, components, and/or combinations thereof.

It should be noted that the terms “first” and “second” in the description and claims of the application and the above mentioned drawings are used to distinguish similar objects, and not necessarily used to describe a specific order or sequence. It should be understood that a data used in this way may be interchanged under appropriate circumstances, so that the embodiments of the present disclosure described herein may be implemented in a sequence other than those illustrated or described herein. In addition, the terms “include”, “have” and any variations of them are intended to cover non-exclusive inclusions. For example, a process, method, system, product, or device that includes a series of steps or units is not necessarily limited to those clearly listed steps or units, but may include other steps or units that are not clearly listed or are inherent to these process, method, product, and devices.

The above descriptions are only preferred embodiments of the present invention and are not intended to limit the present disclosure. For those skilled in art, the present disclosure may have various modifications and changes. Any modification, equivalent replacement, improvement, etc. made within spirit and principle of the present disclosure should be included in a protection scope of the present disclosure.

What is claimed is:

1. An anti-overflow cooking utensil with stable support, comprising:
a pot body (1);
a pot cover (2);
a handle (3);
ear handles (4); and
rectangular openings (5);
wherein the pot cover (2) is disposed on an upper portion of the pot body (1), an anti-overflow ring (35) is fixedly disposed at one end of an inner wall of the pot cover (2), a handle (3) is connected to an upper portion of the pot cover (2), a tensioning mounting mechanism is disposed between the handle (3) and the pot cover (2), a supporting block (20) is fixedly disposed at each of two opposite ends of a bottom of the pot body (1), fixing blocks (6) are fixedly disposed at upper ends of two opposite sides of the pot body (1), first pin shafts (7), penetrating through outer walls of two sides of each of the fixing blocks, are rotatably disposed on the pot body (1), ear handles (4) are respectively and fixedly disposed at two ends of each of the first pin shafts (7), the rectangular openings (5), penetrating through outer walls of two sides of each of the ear handles (4), are respectively defined on each of the ear handles (4), L-shaped rods (8) are respectively disposed on each of two sides of the pot body (1) near the ear handles (4), upper ends of the L-shaped rods (8) respectively penetrate through the rectangular openings (5), rotating shafts (9), penetrating through the outer walls of the two sides of the L-shaped rods (8), are rotatably disposed at the upper ends of the L-shaped rods (8), pressing wheels (11) are fixedly disposed at two ends of each of the rotating shafts (9), and auxiliary pressing mechanisms are disposed on outer walls of the two sides of the pot body (1).

2. The anti-overflow cooking utensil with stable support according to claim 1, wherein limiting pins (10) are fixedly disposed at two ends of an upper portion of each of the fixing blocks (6), limiting strips (15) are fixedly disposed at two ends of a lower portion of each of the fixing blocks (6), a free rotation gap is formed between a respective one of the limiting pins (10) and a respective one of the limiting strips (15), a connecting strip (13) is horizontally and fixedly disposed on an inner wall of one side of each of the rectangular openings (5), a roller (14) is rotatably disposed in one section of the connecting strip (13), the roller (14) is connected to one side of a respective one of the L-shaped rods (8), and a plurality of anti-skid protrusions (12) are disposed at one end of a lower portion of each of the ear handles (4).

3. The anti-overflow cooking utensil with stable support according to claim 2, wherein each of the auxiliary pressing mechanisms comprises a fixing sleeve fixedly disposed on a lower portion of an outer wall of each of two opposite sides of the pot body (1); a second pin shaft (32), penetrating through two ends of the fixing sleeve (16), is rotatably disposed at the fixing sleeve (16), a first torsion spring is disposed between the second pin shaft (32) and the fixing sleeve (16), two ends of the second pin shaft (32) are both fixedly connected with two connecting rods (18), a grounding roller (17) is rotatably disposed on lower portions of the two connecting rods (18), two L-shaped columns (19) are fixedly disposed on upper ends of the connecting rods (18), and a pressing column (31) is fixedly disposed on upper ends of the two L-shaped columns (19).

4. The anti-overflow cooking utensil with stable support according to claim 3, wherein the tensioning mounting mechanism comprises a through opening defined in a middle portion of the pot cover (2); a sealing sleeve (21) is respectively and fixedly disposed along one end of an inner wall of the through opening, a connecting sleeve (23) is respectively disposed at an upper end of the sealing sleeves (21), a limiting ring (24) is fixedly sleeved on an outer wall of the connecting sleeve (23), and the limiting ring (24) is in contact with an upper portion of the sealing sleeve (21); an upper end of the connecting sleeve (23) is rotatably connected with the handle (3), a plug (22) is inserted between a lower end of the sealing sleeve (21), and a clamping connection assembly is disposed between the plug (22) and the connecting sleeve (23).

5. The anti-overflow cooking utensil with stable support according to claim 4, wherein the clamping connection assembly comprises a sliding sleeve (28) slidably inserted in the connecting sleeve (23), an inner thread is disposed along an upper end of an inner wall of the sliding sleeve (28), a threaded column (30) is fixedly disposed at a middle position of a lower portion of the handle (3), the threaded column (30) is in threaded connection with an upper end of the sliding sleeve (28), an annular clamping groove (29) is defined in a lower end of the sliding sleeve (28) along the inner wall of the sliding sleeve (28), clamping rods (26) are respectively and rotatably disposed on two sides of an upper portion of the plug (22), a clamping head is disposed on an upper portion of each of the clamping rods (26), the clamping head is matched with the annular clamping groove (29), and a second torsion spring is disposed at a position where the clamping rod (26) is rotatably connected with the plug (22).

6. The anti-overflow cooking utensil with stable support according to claim 5, wherein side grooves (25) are respectively defined in lower portions of inner walls of two sides of the connecting sleeve (23), sliding blocks (27) are fixedly disposed on outer walls of two sides of the sliding sleeve (28), and the sliding blocks (27) are respectively and slidably disposed in the side grooves (25).

7. The anti-overflow cooking utensil with stable support according to claim 6, wherein one end of a spring (34) is fixedly connected to an inner top wall of each of the side grooves (25), and an other end of the spring (34) is fixedly disposed on an upper portion of each of the sliding blocks (27).

8. The anti-overflow cooking utensil with stable support according to claim 6, wherein two magnetic blocks (33) are respectively and fixedly disposed on the inner top wall of each of the side grooves (25) and the upper portion of each of the sliding blocks (27), and the two magnetic blocks (33) are magnetically repulsive.
